(19) United States
(12) Patent Application Publication
(10) Pub. No.: US 2017/0249430 A1
(43) Pub. Date: Aug. 31, 2017

(54) METHODS, APPARATUSES AND COMPUTER PROGRAM PRODUCTS FOR PROVIDING A KNOWLEDGE HUB HEALTH CARE SOLUTION

(71) Applicant: CARADIGM USA LLC, Bellevue, WA (US)

(72) Inventors: Jonathan D'Souza, Austin, TX (US); Navpreet Singh, Redmond, WA (US)

(21) Appl. No.: 15/411,038

(22) Filed: Jan. 20, 2017

Related U.S. Application Data
(63) Continuation of application No. 13/840,632, filed on Mar. 15, 2013, now abandoned.

(51) Int. Cl. G06F 19/00

(52) U.S. Cl. CPC G06F 19/3406; G06F 19/322

(57) ABSTRACT

An apparatus is provided for presenting patient medical information. The apparatus may include at least one memory and at least one processor configured to analyze medical data of a patient generated by a primary clinical application. The medical data may be currently presented via a first window of a user interface for evaluation by a user. The processor is also configured to determine a context of the medical data or an action(s) performed by the user on behalf of the patient. The processor is also configured to detect additional information corresponding to the patient. The additional information may be received from different health care entities. The processor may also be configured to generate a panel including visible indicia denoting the additional information of the patient for consideration by the user. The panel may be arranged adjacent to the first window. Corresponding computer program products and methods are also provided.

### TECHNOLOGICAL FIELD

Embodiments of the invention relate generally to a mechanism of facilitating user interaction with health care data and more particularly relate to a method, apparatus and computer program product for presenting patient information of interest at a point of care for evaluation.

### BACKGROUND

Currently, clinicians providing direct care to patients in inpatient or acute care settings are usually interacting with their point of care systems (e.g., an electronic medical record (EMR) system) on a transactional basis as they carry out their various tasks from patient to patient. Clinician productivity is a key factor for many health care organizations to drive down costs, and increase patient satisfaction. Additionally, quality of care may greatly be enhanced by providing the right information to a clinician at the appropriate time.

Many point of care systems today are optimized for the task at hand such as for example, placing an order for an X-ray, writing a discharge note, recording vitals, updating patient history, reviewing a lab result, etc. However, today's point of care systems, typically lack the comprehensiveness of clinical information for a patient (and patient populations) across the continuum of care to be able to provide the adequate depth of insight and/or decision support.

In view of the foregoing drawbacks, there may be a need for an efficient and reliable mechanism to provide more health care information, insight as well as guide appropriate actions for patients in an efficient and impactful manner at a point of care.

### BRIEF SUMMARY

A method, apparatus and computer program product are therefore provided that may provide an efficient and reliable mechanism of data aggregation and normalization enabling presentation of information, insights derived from the information as well as suggestions for action via additional applications at a point of care for interaction of a clinician.

By utilizing the exemplary embodiments, a clinician may be provided a user interface including additional information, insight and/or guidance for action in the context of a specific patient leveraging one or more of the following capabilities: (1) a non-intrusive indicator that indicates to a user (clinician) that there is additional information/guidance about a specific patient they are evaluating in a primary clinical application; (2) a slide-out panel that presents pertinent information (e.g., healthcare information) and serves as a launch pad to additional applications/workflows as needed without forcing a user (e.g., a clinician) to switch away from the primary clinical application; (3) present additional information regarding a patient via one or more launch points; or (4) any other suitable capabilities.

In one example embodiment, a method for presenting patient medical information is provided. The method may include analyzing medical data of a patient generated by a primary clinical application. The medical data may be currently presented via a first window of a user interface for evaluation by a user. The method may further include determining a context of the medical data of the patient or one or more actions being performed by the user on behalf of the patient. The method may further include detecting additional relevant information corresponding to the patient. The additional relevant information is received from one or more different health care entities. The method may further include generating a panel including visible indicia denoting the additional relevant information corresponding to the patient for consideration by the user. The panel may be arranged adjacent to the first window.

In another example embodiment, an apparatus for presenting patient medical information is provided. The apparatus may include a processor and a memory including computer program code. The memory and computer program code are configured to, with the processor, cause the apparatus to at least perform operations including analyzing medical data of a patient generated by a primary clinical application. The medical data may be currently presented via a first window of a user interface for evaluation by a user. The memory and computer program code are also configured to, with the processor, cause the apparatus to determine a context of the medical data of the patient or one or more actions being performed by the user on behalf of the patient. The memory and computer program code are also configured to, with the processor, cause the apparatus to detect additional relevant information corresponding to the patient. The additional relevant information is received from one or more different health care entities. The memory and computer program code are also configured to, with the processor, cause the apparatus to generate a panel including visible indicia denoting the additional relevant information corresponding to the patient for consideration by the user. The panel may be arranged adjacent to the first window.

In another example embodiment, a computer program product for presenting patient medical information is provided. The computer program product includes at least one computer-readable storage medium having computer-executable program code instructions stored therein. The computer-executable program code instructions may include program code instructions configured to analyze medical data of a patient generated by a primary clinical application. The medical data may be currently presented via a first window of a user interface for evaluation by a user. The computer program product may further include program code instructions configured to determine a context of the medical data of the patient or one or more actions being performed by the user on behalf of the patient. The computer program product may further include program code instructions configured to detect additional relevant information corresponding to the patient. The additional relevant information is received from one or more different health care entities. The computer program product may further include program code instructions configured to generate a panel including visible indicia denoting the additional relevant information corresponding to the patient for consideration by the user. The panel may be arranged adjacent to the first window.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a communication device according to an exemplary embodiment of the invention;

FIG. 3 is a schematic block diagram of a computing device according to an exemplary embodiment of the invention;

FIGS. 4 and 5 are diagrams illustrating user interfaces including knowledge hub panel according to exemplary embodiments of the invention; and

FIG. 6 is a flowchart of an exemplary method according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### General System Architecture

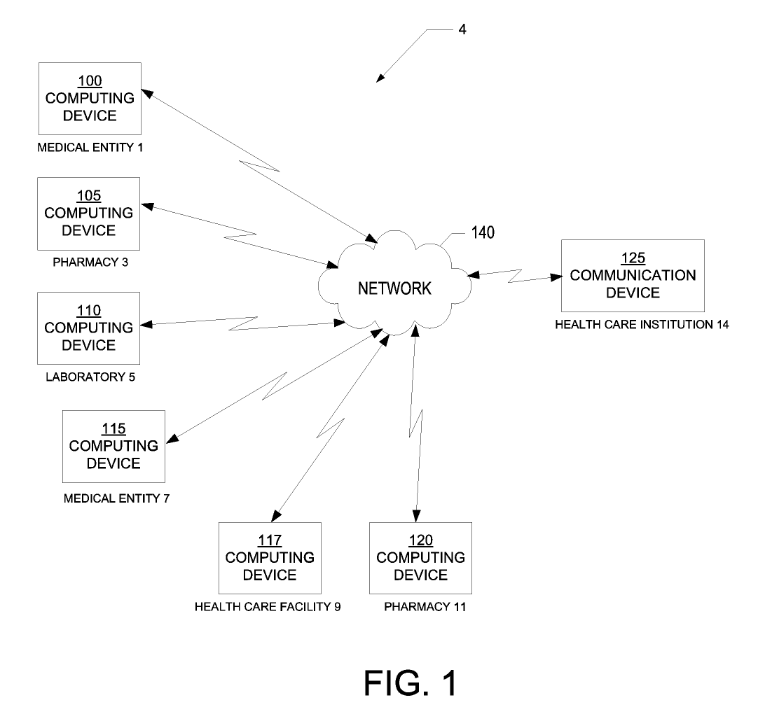

Referring now to FIG. 1, a block diagram of a system according to an exemplary embodiment is provided. As shown in FIG. 1, the system 4 (e.g., a health care system) may include one or more computing devices 100, 105, 110, 115, 117 and 120 (e.g., personal computers, laptops, tablet computing devices, workstations, servers, personal digital assistants, smart devices and the like, etc.) which may access one or more network entities such as, for example, a communication device 125 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 125 is capable of receiving data from and transmitting data to the computing devices 100, 105, 110, 115, 117 and 120 via network 140.

In one exemplary embodiment, the computing devices 100, 105, 110, 115, 117 and 120 may be utilized by clinicians (e.g., physicians, nurses, pharmacists, psychologists, social workers, physical therapists, laboratory technicians, etc.) and/or any other suitable health care professionals. The computing devices 100, 105, 110, 115, 117, 120 may be maintained by one or more health care institutions. For instance, the computing device 100 may be maintained by a medical entity 1 (e.g., a medical clinic), the computing device 105 may be maintained by a pharmacy 3, the computing device 110 may be maintained by a laboratory 5. In addition, the computing device 115 may be maintained by a medical entity 7 (e.g., a hospital), the computing device 117 may be maintained by a health care facility 9 (e.g., a psychotherapy entity (e.g., a psychiatric office, an office of a social worker, etc.) and the computing device 120 may be maintained by the pharmacy 11. In an exemplary embodiment, the communication device 125 may be maintained by a health care institution 14. The communication device 125 may be utilized by one or more clinicians.

The communication device 125 may communicate with the computing devices 100, 105, 110, 115, 117, and 120. In this regard, the communication device 125 may receive medical information from and may transmit medical information to the computing devices 100, 105, 110, 115, 117, and 120. The medical information may be utilized by the communication device 125 to generate a user interface providing additional information, insight and/or guidance for one or more actions that relate to clinical data associated with a primary clinical application being presented (e.g., via a user interface) to a clinician for a particular patient(s), as described more fully below.

It should be pointed out that although FIG. 1 shows six computing devices 100, 105, 110, 115, 117, 120 and one communication device 125 any suitable number of computing devices 100, 105, 110, 115, 117, 120 and communication devices 125 may be part of the system of FIG. 1 without departing from the spirit and scope of the invention.

### Communication Device

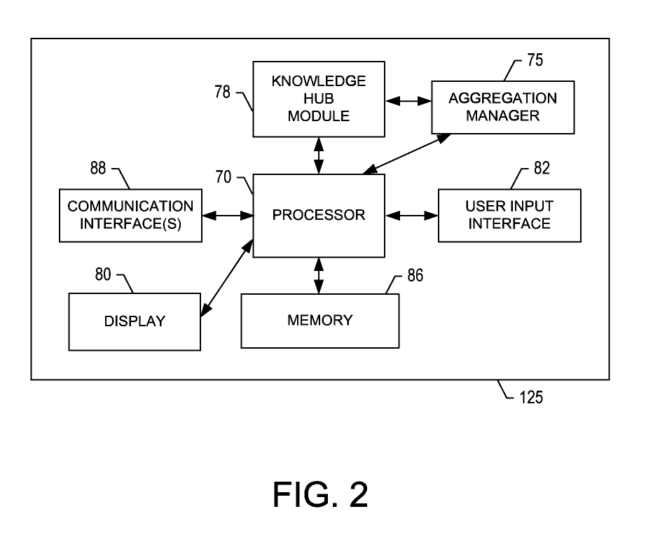

Referring now to FIG. 2, a block diagram of a communication device is provided according to an exemplary embodiment of the invention. The communication device 125 may, but need not, be a network device such as, for example, a server. The communication device 125 may include various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 125 may include a processor 70 connected to a memory 86. The memory may comprise volatile and/or non-volatile memory, and typically stores content (e.g., media content, medical information, etc.), data, information or the like.

For example, the memory may store content transmitted from, and/or received by, the computing devices 100, 105, 110, 115, 117 and 120. In this regard, in an exemplary embodiment, the memory 86 may store data received from various disparate sources. For example, the memory 86 may store medical information received by the communication device 125 from the computing devices of the medical entity 1, the pharmacy 3, the laboratory 5, the medical entity 7, the health care facility 9 and the pharmacy 11, etc. The medical information may include, but is not limited to, prescriptions, medications, medical diagnoses, laboratory results, medical tests or measurements, medical chart information, medical imaging information (e.g., magnetic resonance imaging (MRI) of the human body), alert/notification data and any other suitable information.

The medical information received by the communication device 125 from the computing devices 100, 105, 110, 115, 117, 120 may include one or more patient identifiers of respective patients. For example, medical record numbers (MRNs) may be utilized as patient identifiers to identify respective patients. In addition, or alternatively, patient demographic data (e.g., biographical data (e.g., name, date of birth, etc.), race, age, gender, etc.) may be utilized to identify one or more patients.

Additionally, for example, the memory 86 typically stores client applications, instructions, algorithms or the like for execution by the processor 70 to perform steps associated with operation of the communication device 125 in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 125 may include one or more logic elements for performing various functions of one or more client applications. In an exemplary embodiment, the communication device 125 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, computing devices 100, 105, 110, 115, 117, 120 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface may support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control an aggregation manager 75. The aggregation manager 75 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the aggregation manager 75, as described below. In examples in which software is employed, a device or circuitry (e.g., processor 70 in one example) executing the software forms the structure associated with such means. As such, for example, the aggregation manager 75 may be configured to, among other things, receive and manage medical data from multiple different sources/entities such as, for example, computing devices 100, 105, 110, 115, 117, 120 maintained respectively by the medical entity 1, the pharmacy 3, the laboratory 5, the medical entity 7, the health care facility 9 and the pharmacy 11, as described more fully below.

Additionally, in an example embodiment, the processor 70 may be in communication with and may otherwise control a knowledge hub module 78. The knowledge hub module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the knowledge hub module 78, as described below. In examples in which software is employed, a device or circuitry (e.g., processor 70 in one example) executing the software forms the structure associated with such means. As such, for example, the knowledge hub module 78 may be configured to, among other things, receive data, from the aggregation manager 75, related to a patient that is currently being evaluated by a clinician based on information of a primary clinical application and may present additional relevant data (e.g., medical data) regarding the patient to a user interface for consideration by the clinician, as described more fully below.

### Computing Device

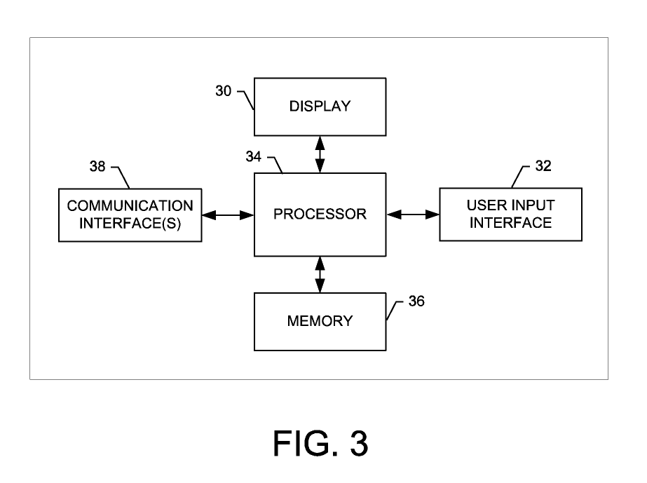

Referring now to FIG. 3, a block diagram of a computing device according to an exemplary embodiment is provided. The computing device is capable of operating as any of computing devices 100, 105, 110, 115, 117 and 120. In this regard, the computing devices 100, 105, 110, 115, 117, and 120 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. In addition, the memory device 36 may store client applications, software (e.g., software code) algorithms, instructions or the like for the processor 34 to perform steps associated with operation of the computing device.

The memory device 36 may store medical information (e.g., medical diagnoses, laboratory results, medications, prescriptions, medical visit information, etc.) associated with one or more patients. The medical information may include one or more patient identifiers (e.g., MRNs) identifying respective patients (e.g., Jane Doe, a fictitious patient) and/or biographic data.

In an instance in which medical information of one or more of the patients is sent to the communication device 125, by the processor 34, the aggregation manager 75 of the communication device 125 may detect a patient identifier(s) (e.g., a MRN(s), biographic data, etc.) to identify respective patients and corresponding medical data. In this manner, the manager 75 may maintain and manage data received from various sources/entities (e.g., medical entities, pharmacies, laboratories health care facilities, etc.) pertaining to one or more patients.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display or any other input device.

### Exemplary System Operation

Exemplary embodiments of the invention may provide an efficient and reliable mechanism for providing a non-intrusive indicator informing a user (e.g., a clinician) that there is additional information (e.g., medical information) or guidance (e.g., suggested medical tasks) about a specific patient that the user (e.g., a clinician) may be evaluating in a primary clinical application. In this regard, the exemplary embodiments may analyze patient data and other context from a primary clinical application utilized by a user (e.g., a clinician) to compute or determine relevant additional information (e.g., medical information corresponding to the patient), insight and/or actionable guidance pertaining to the patient. As such, the exemplary embodiments may provide non-intrusive alerting to the user (e.g., a clinician) of the availability of additional information (e.g., medical information) and/or guidance relating to the patient being evaluated based on medical data from a primary clinical application. The exemplary embodiments may also enable the user to view the additional information without switching away from the primary clinical application.

In an exemplary embodiment, the knowledge hub module 78 may analyze data of a primary clinical application and may know or determine that a clinician is logged in to the primary clinical application and that the clinician is evaluating a particular patient (e.g., Jane Doe). Based in part on analyzing the data of the primary clinical application, the knowledge hub module 78 may also determine one or more actions that the clinician is taking or considering in the in the primary clinical application. For example, the knowledge hub module 78 may determine that the clinician is placing a medication order or placing an X-ray order for patient Jane Doe. As such, the knowledge hub module 78 may consider the context from the primary clinical application and determine the actions of the clinician in the primary clinical application. In response to detecting the actions of the clinician in the primary clinical application for the patient (e.g., patient Jane Doe), the knowledge hub module 78 may evaluate received data (e.g., aggregated data) from the aggregation manager 75 and calculate or determine relevant information corresponding to the patient (e.g., patient Jane Doe) that may be useful for the clinician (for example, useful to the clinician while the clinician places the medication order or X-ray order for patient Jane Doe).

In this regard, for example, the knowledge hub module 78 may look up allergies and past medical history of patient Jane Doe in the data received from the aggregation manager 75 to provide some information about the kinds of medications or drugs that cause patient Jane Doe to have an allergic reaction. This information may not be available in the primary clinical application.

Additionally, the knowledge hub module 78 may be aware of the context that the primary clinician application is presenting to the clinician regarding a patient. In this regard, the knowledge hub module may utilize the context to present relevant information (e.g., medical information) or suggestions for one or more actions to take/perform regarding the patient. In this regard, the knowledge hub module 78 may present one or more launch points to take or accept the actions in an instance in which the clinician so desires.

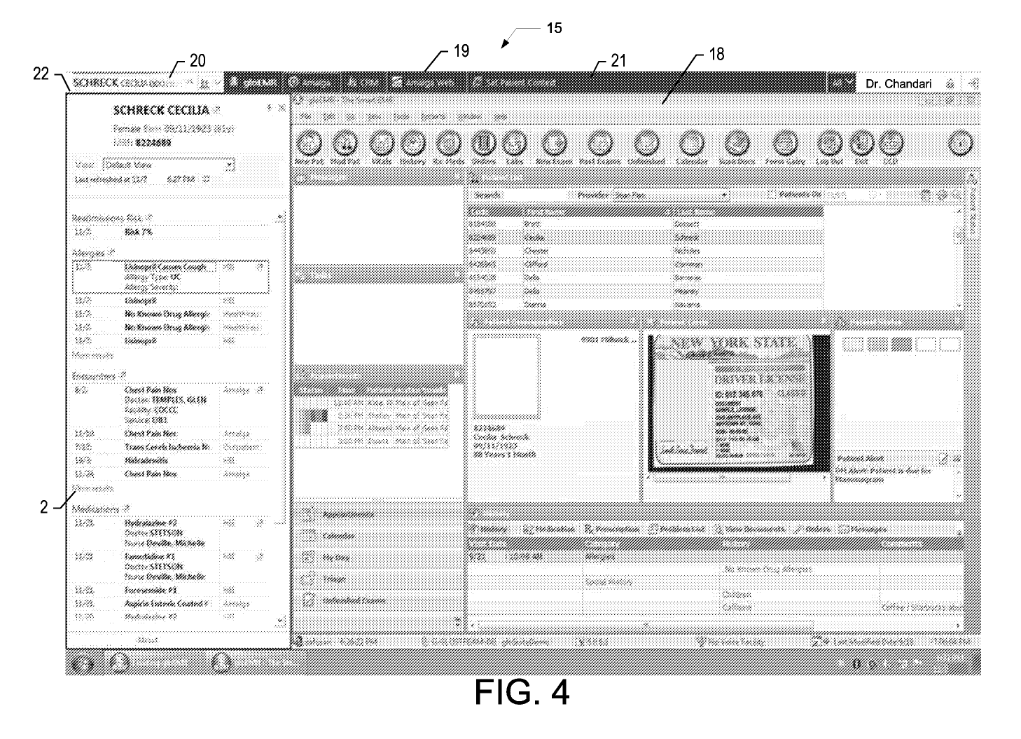

Referring now to FIG. 4, a diagram of a user interface including a knowledge hub panel is provided according to an exemplary embodiment. The knowledge hub module 78 may generate the user interface 19. In the example embodiment of FIG. 4, a clinician such as, for example, Dr. Chandari (e.g., a fictitious physician) is working in a local electronic medical record (also referred to herein as primary clinical application) (for instance, GloEMR in this example) in a window 18 (also referred to herein as EMR window 18 or primary clinical application window 18) of the user interface 19 while examining patient Cecilia Schreck (e.g., a fictitious patient). In the launch pad 21 at the top of the display 15 (e.g., display 80), the knowledge hub module 78 may include (e.g., automatically include) visible indicia of an indicator 20 denoting there is additional information (e.g., medical information) for patient Cecilia Schreck that may be relevant (e.g., information that is not in EMR window 18) for evaluation or consideration by the clinician Dr. Chandari.

The knowledge hub module 78 may determine that there is additional relevant data (e.g., medical data) for patient Cecilia Schreck in response to receiving patient data (e.g., aggregated data) from the aggregation module 75 while the EMR window 18 is launched and indicating visible indicia pertaining to patient Cecilia Schreck. The aggregation module 75 may receive the data pertaining to patient Cecilia Schreck and one or more other patients from one or more disparate/different sources or entities (e.g., medical entity 1, medical entity 7, pharmacy 3, pharmacy 11, laboratory 5, health care facility 9, etc.).

In response to receipt of an indication of a selection, by the clinician Dr. Chandari, of a pull down via the launch pad 21, the knowledge hub module 78 may generate a knowledge hub panel 22 with visible indicia indicating information about patient Cecilia Schreck that may be unavailable in the EMR window 18 (e.g., the primary clinical application window 18). As described above, the information (e.g., additional medical information pertaining to patient Cecilia Schreck) of the knowledge hub panel 22 may be aggregated from other systems (e.g., medical entity 1, pharmacy 11, laboratory 5, etc.) by the aggregation module 75 and provided to the knowledge hub module 78 for generation of the knowledge hub panel 22.

In this regard, the knowledge hub module 78 may evaluate patient data of the EMR 18 and in response to identifying the patient indicated (e.g., via a MRN, biographic information (e.g., name, date of birth, etc.)) in the EMR window 18, the knowledge hub module 78 may determine whether there is relevant data (e.g., medical data) associated with the patient received from one or more disparate sources. In an instance in which the knowledge hub module 78 determines that there is information available for the patient (e.g., by matching the MRN or biographic data with the patient), the knowledge hub module 78 may generate a knowledge hub panel 22 indicating all or a subset of the patient data received from the disparate sources.

In some example embodiments, the knowledge hub module 78 may analyze the data received by the one or more disparate sources (e.g., via aggregation module 75) and compute/calculate data on behalf of the patient. For instance, in the example embodiment of FIG. 4, the knowledge hub module 78 computed/calculated the readmission risk score for patient Cecilia Schreck. The readmission risk score may denote the probability that patient Cecilia Schreck may be readmitted to a health institution (e.g., hospital) within a time period (e.g., the next 30 days).

The knowledge hub module 78 may generate the visible indicia of the knowledge hub panel (e.g., knowledge hub panel 22) side-by-side with a primary clinical application window (e.g., EMR window 18). The visible indicia for viewing in a knowledge hub panel may be pre-designated. For instance, in the example embodiment of FIG. 4, a default view is pre-designated as well as pre-designations for readmissions risks, allergies, encounters (e.g., patient visits in a health institution (e.g., a hospital)), medications and any other suitable pre-designated selections of data.

In the example embodiment of FIG. 4, the Dr. Chandari may quickly glance through the knowledge hub panel 22 and view the information pertaining to patient Cecilia Schreck. In response to receipt of an indication of a selection, by Dr. Chandari, of a more results tab, such as for example a more results tab associated with medications, the knowledge hub module 78 may launch a window (e.g., passing user and patient context so the clinician does not have to re-log on or re-select the patient) with more medication details.

In response to receipt of an indication of a more results tab, the knowledge hub module 78 may also present one or more suggestions for action including a launch point or a hyperlink to allow the user to accept the suggested action(s). For purposes of illustration and not of limitation, presume for example, that a clinician (e.g., an emergency department nurse) is performing a triage for a patient. In this example, presume that the knowledge hub panel indicates (e.g., in an encounters section) that a patient has actually been to multiple emergency rooms in the region in the last two months and complaining of pain and requesting pain relief medication.

In this regard, the knowledge hub module 78 may generate a flag indicating that the patient is a potential drug seeker and may set up a flag to page or send a notification to someone such as for example, a social worker, or psychiatrist to come and talk to the patient. In this example, the user (e.g., emergency department nurse) may be presented with visible indicia suggesting to take the proposed action to notify someone (e.g., send a message to a social worker of a health care facility (e.g., health care facility 9)) to counsel the patient about the pain relief drugs in response to receipt of an indication denoting that the user selected a more results tab (e.g., more results tab 2) (also referred to herein as more results link 2) associated with encounters via the knowledge hub panel (e.g., knowledge hub panel 23).

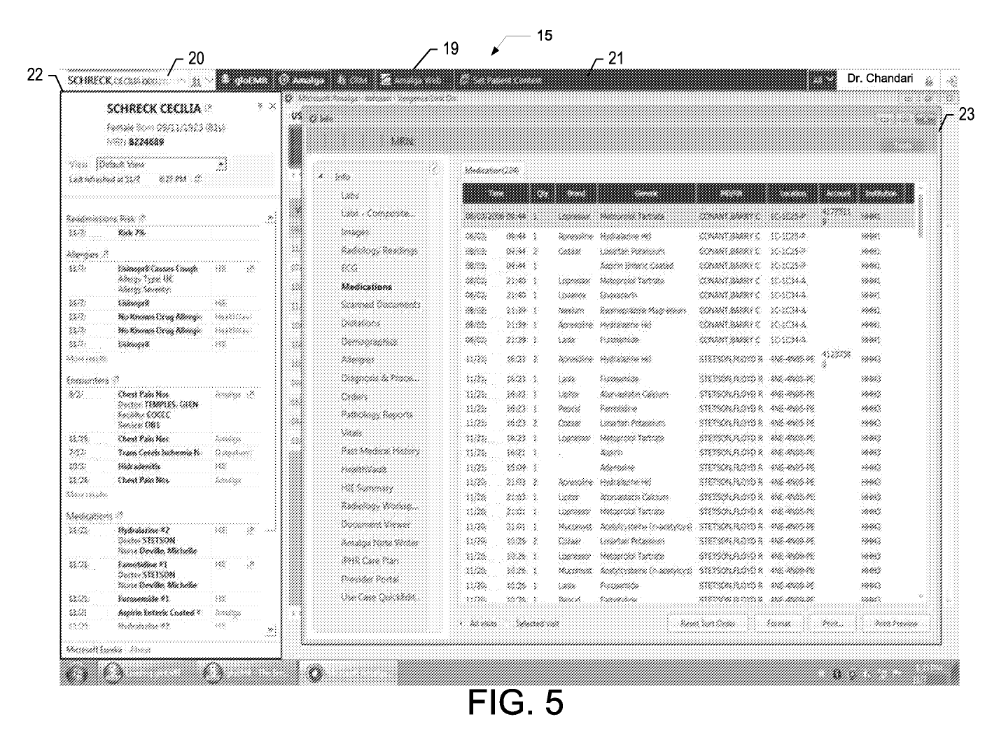

Referring now to FIG. 5, a diagram illustrating a launched window is provided according to an exemplary embodiment. In the example embodiment of FIG. 5, the knowledge hub module 78 may generate window 23 (also referred to herein as intelligence platform window 23) in response to receipt of an indication of a selection of a more results tab associated with medications, for example, in the knowledge panel hub 22. In this regard, the knowledge hub module 78 may generate visible indicia of the window indicating medications of a patient, such as Cecilia Schreck in this example.

In this regard, in addition to the launch pad 21 being a hub from which a user may launch one or more applications in a context (e.g., user context, patient context, etc., as appropriate), the knowledge hub panel 22 may be a hub for various applications (e.g., an allergies application, an encounters application, a medications application) to display relevant summary information in a full application (e.g., window 23 illustrating medications of a patient) in response to accessing a launch point (e.g., a more results tab).

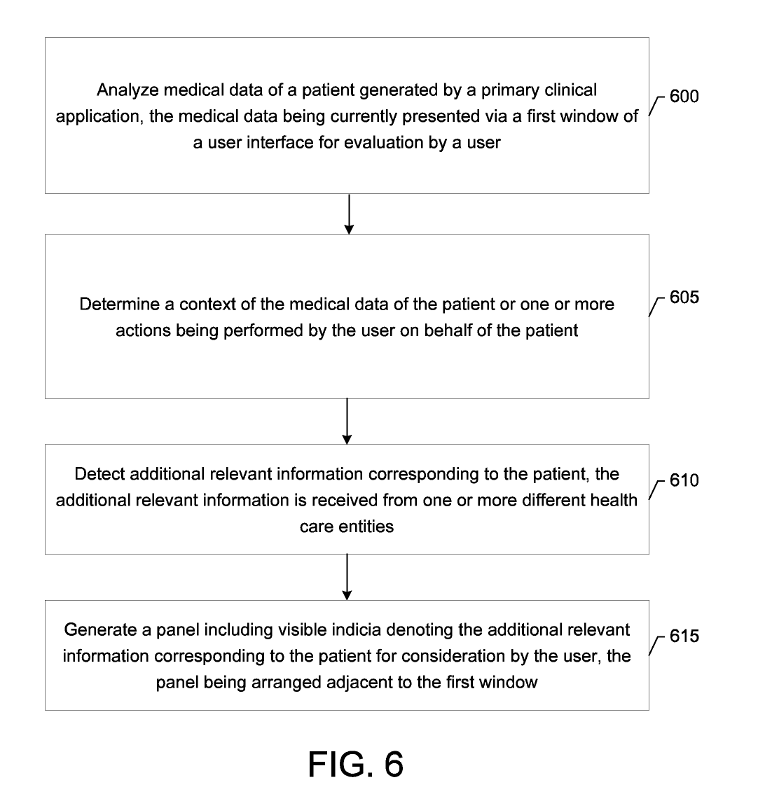

Referring now to FIG. 6, an exemplary method for providing additional data of a patient corresponding to information of the patient from a primary clinical application is provided according to an exemplary embodiment. At operation 600, an apparatus (e.g., communication device 125) may analyze medical data of a patient (e.g., Cecilia Schreck) generated by a primary clinical application (e.g., an EMR). The medical data may be currently presented via a first window (e.g., EMR window 18) of a user interface (e.g., user interface 19) for evaluation by a user (e.g., a clinician). At operation 605, the apparatus (e.g., communication device 125) may determine a context of the medical data of the patient or one or more actions (e.g., ordering a medication for the patient, ordering an X-ray for the patient) being performed by the user on behalf of the patient.

At operation 610, the apparatus (e.g., communication device 125) may detect additional relevant information corresponding to the patient. The additional relevant information may be received from one or more different health care entities (e.g., medical entity 1, pharmacy 3, laboratory 5, medical entity 7, health care facility 9, pharmacy 11, etc.) At operation 615, the apparatus (e.g., communication device 125) may generate a panel (e.g., knowledge hub panel 22) including visible indicia denoting the additional relevant information corresponding to the patient for consideration by the user. The panel (e.g., knowledge hub panel 22) may be arranged, by the knowledge hub module 78, adjacent (e.g., side-by-side) to the first window (e.g., EMR window 18) of the user interface (e.g., user interface 19).

It should be pointed out that FIG. 6 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86) and executed by a processor (e.g., processor 70, knowledge hub module 78, aggregation manager 75). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 6 above may comprise a processor (e.g., the processor 70, the knowledge hub module 78, the aggregation manager 75) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70 (e.g., as means for performing any of the operations described above), the knowledge hub module 78, the aggregation module 75 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
analyzing medical data of a patient generated by a primary clinical application, the medical data being currently presented via a first window of a user interface for evaluation by a user;
determining a context of the medical data of the patient or one or more actions being performed by the user on behalf of the patient;
detecting additional relevant information corresponding to the patient, the additional relevant information is received from one or more different health care entities; and
generating a panel comprising visible indicia denoting the additional relevant information corresponding to the patient for consideration by the user, the panel being arranged adjacent to the first window.

2. The method of claim 1, wherein:
the additional relevant information corresponding to the patient for consideration by the user comprises one or more suggestions for one or more actions to perform by the user on behalf of the patient.

3. The method of claim 1, wherein prior to generating the panel, the method further comprises:
generating an indicator in the user interface, the indicator comprises visible indicia denoting that the additional relevant information corresponding to the patient is available for evaluation by the user.

4. The method of claim 3, wherein the indicator is arranged in a launch pad of the user interface.

5. The method of claim 1, wherein at least a subset of the additional relevant information is unavailable in the medical data generated by the primary clinical application in the first window.

6. The method of claim 1, wherein prior to generating the panel, the method further comprises:
analyzing the additional relevant information; and
utilizing at least a subset of the additional relevant information to calculate medical information pertaining to the patient.

7. The method of claim 6, further comprising:
including visible data denoting the calculated medical information in the panel.

8. The method of claim 1, wherein:
generating the panel further comprises including one or more launch points in the panel configured to enable access to other items of medical content of the patient.

9. The method of claim 8, further comprising:
generating another window comprising the other medical content of the patient in response to receipt of an indication of a selection of one of the launch points to provide insight to the user regarding care of the patient or one or more suggested actions to perform by the user on behalf of the patient.

10. An apparatus comprising at least one processor and at least one memory including computer program code, the at least one memory and the computer program code configured to, with the processor, cause the apparatus to at least:
analyze medical data of a patient generated by a primary clinical application, the medical data being currently presented via a first window of a user interface for evaluation by a user;
determine a context of the medical data of the patient or one or more actions being performed by the user on behalf of the patient;
detect additional relevant information corresponding to the patient, the additional relevant information is received from one or more different health care entities; and
generate a panel comprising visible indicia denoting the additional relevant information corresponding to the patient for consideration by the user, the panel being arranged adjacent to the first window.

11. The apparatus of claim 10, wherein the additional information corresponding to the patient for consideration by the user comprises one or more suggestions for one or more actions to perform by the user on behalf of the patient.

12. The apparatus of claim 10, wherein prior to generate the panel, the memory and computer program code are further configured to, with the processor, cause the apparatus to:
generate an indicator in the user interface, the indicator comprises visible indicia denoting that the additional relevant information corresponding to the patient is available for evaluation by the user.

13. The apparatus of claim 12, wherein the indicator is arranged in a launch pad of the user interface.

14. The apparatus of claim 10, wherein at least a subset of the additional relevant information is unavailable in the medical data generated by the primary clinical application in the first window.

15. The apparatus of claim 10, wherein prior to generate the panel, the memory and computer program code are further configured to, with the processor, cause the apparatus to:
analyze the additional relevant information; and
utilize at least a subset of the additional relevant information to calculate medical information pertaining to the patient.

16. The apparatus of claim 15, wherein the memory and computer program code are further configured to, with the processor, cause the apparatus to:
include visible data denoting the calculated medical information in the panel.

17. The apparatus of claim 10, wherein the memory and computer program code are further configured to, with the processor, cause the apparatus to:
generate the panel by including one or more launch points in the panel configured to enable access to other items of medical content of the patient.

18. The apparatus of claim 17, wherein the memory and computer program code are further configured to, with the processor, cause the apparatus to:
generate another window comprising the other medical content of the patient in response to receipt of an indication of a selection of one of the launch points to provide insight to the user regarding care of the patient or one or more suggested actions to perform by the user on behalf of the patient.

19. A computer program product comprising at least one non-transitory computer-readable storage medium having computer-executable program code instructions stored therein, the computer executable program code instructions comprising:
program code instructions configured to analyze medical data of a patient generated by a primary clinical application, the medical data being currently presented via a first window of a user interface for evaluation by a user;
program code instructions configured to determine a context of the medical data of the patient or one or more actions being performed by the user on behalf of the patient;
program code instructions configured to detect additional relevant information corresponding to the patient, the additional relevant information is received from one or more different health care entities; and
program code instructions configured to generate a panel comprising visible indicia denoting the additional relevant information corresponding to the patient for consideration by the user, the panel being arranged adjacent to the first window.

20. The computer program product of claim 19, wherein the additional relevant information corresponding to the patient for consideration by the user comprises one or more suggestions for one or more actions to perform by the user on behalf of the patient.
